(19) United States
(12) Patent Application Publication
(10) Pub. No.: US 2003/0187808 A1
(43) Pub. Date: Oct. 2, 2003

(54) Electronic cost estimator for processing of paper products

(76) Inventors: Walter K. Alfred, Indianapolis, IN (US); Sandy L. Eckert, Indianapolis, MN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/402,195

(22) Filed: Mar. 28, 2003

Related U.S. Application Data
(60) Provisional application No. 60/369,071, filed on Mar. 29, 2002.

(51) Int. Cl. G06G 7/00; G06F 17/00

(52) U.S. Cl. 705/400

(57) ABSTRACT

The present invention provides a method for estimating the cost of a custom-processed or custom-printed paper product. The method includes the step of receiving a request for a custom-processed or custom-printed paper product, where the request includes at least one product requirement. The method also includes the step of determining an estimated cost of manufacturing the requested custom-processed or custom-printed paper product based at least in part on the at least one product requirement.

### RELATED APPLICATION

This application claims the benefit of U.S. Provisional Application No. 60/369,071 filed Mar. 29, 2002 and incorporated herein by this reference.

### BACKGROUND AND SUMMARY OF THE INVENTION

The present invention relates to computer software and hardware for the paper converting and business forms printing industry. More particularly, the present invention relates to a method and apparatus for automatically estimating the cost of a custom-printed or custom-processed paper product based on specific criteria identified by a requester and providing a quotation for the requested product to the requester.

For purposes of this disclosure, “paper products” include, but are not limited to, cash register receipts, automatic teller machine receipts, parking tickets, gaming and lottery tickets, airline “e-tickets” and boarding passes, kiosk media, labels, ribbons, envelopes, business forms (including continuous and cutsheet forms), paper rolls, fanfolded products, and the like, including both stock items and items that are at least partially custom-processed. Custom-processed paper products include paper products that are “non-standard,” for example in terms of size, shape, thickness, number of perforations, number of colors, and/or core size. Custom-processed paper products also include paper products (stock or non-standard items) that are printed with graphics, for example, text and/or designs, company names and/or logos.

The paper products processing industry, in particular, is characterized by a large number of manufacturers with both captive and independent distributors and dealers. Historically, such requesters order paper products from manufacturers by telephone or fax. To prepare a quotation for a requested paper product, a manufacturer uses a manual or partially computerized system to estimate the cost to manufacture the requested product, and then adds a markup. The manufacturer typically delivers the manually-prepared quotation to the distributor by telephone, fax, regular postal mail or e-mail.

In order to prepare a quotation, particularly for a custom-processed paper product, the manufacturer considers a variety of information relating to the requested product, for example, paper type, thickness, dimensions, colors, quality, end user machine types, printing requirements, and/or delivery requirements. In addition, the manufacturer relies on the experience and knowledge of its personnel to determine the particular factors that will affect the quotation. These factors include knowledge of the type of paper (e.g., size, thickness, basis weight) used by the requester's equipment, the types of printing and paper slitting machines that will be required for the manufacturer to process the order, the machine running time necessary for the manufacturer to process the order, the geographic location of the requester, and any additional factors related to the requester and/or manufacturer. The detailed analysis required to prepare a quotation has traditionally made it extremely difficult for manufacturers to deliver quotations to requesters quickly.

Nonetheless, the paper product processing business is competitive. The manufacturer who responds with a quote the fastest increases its chances of getting the job. Similarly, a requester risks losing business to its competitors if a lengthy quotation process delays negotiations with the manufacturer.

There is, therefore, a need for a method and apparatus capable of quickly providing accurate quotations for paper product orders, and particularly for custom-processed paper product orders. The present invention reduces the typical time required to generate a quotation for custom-processed paper products from days or hours to minutes.

The present invention provides a method for estimating the cost of a custom-printed paper roll for use in a printer application. The method includes the step of receiving a request for a custom-printed paper roll, where the request includes a roll diameter and a paper type. The method also includes the step of estimating a cost of manufacturing the requested custom-printed paper roll based at least in part on the roll diameter and the paper type.

According to another aspect of the present invention, a method for estimating the cost of a custom-processed paper product is provided. The method includes the step of receiving a request for a custom-processed paper product, where the request includes at least one product requirement. The method also includes the step of determining an estimated cost of manufacturing the requested custom-processed paper product based at least in part on the at least one product requirement.

The custom-processed paper product may be selected from a group consisting of roll, fan-folded, and sheeted material, utilizing thermal, bond, carbonless, and pressure-sensitive label material. Yet further, the request may be received over a network from a first computing device and the estimated cost of manufacturing the requested custom-processed paper product is determined by a second computing device. The quotation may be based at least in part on the marked-up estimated cost. The quotation is electronically communicated to a requester.

According to another aspect of the present invention, the requested product is selected from a plurality of products stored in a database based on at least one product specification. The product specification is selected from the group consisting of machine make or model, paper type, roll width and diameter. The requested product is determined electronically based on a plurality of specifications.

According to a further aspect of the present invention, the estimated cost of manufacturing the custom-processed paper product is determined based on a plurality of cost factors relating to the manufacture of the custom-processed paper product.

Alternatively, the step of determining an estimated cost includes estimating a total variable cost associated with the manufacture of the custom-processed paper product based at least in part on the at least one requirement, estimating a total fixed cost associated with the manufacture of the custom-processed paper product based at least in part on the at least one requirement, and generating an estimated cost of manufacturing the custom-processed paper product based at least in part on the total variable cost and the total fixed cost.

The total variable cost is estimated based on at least one variable cost factor relating to the manufacture of the custom-processed paper product. The at least one variable cost factor may be one of paper type, paper color, product width, product length, product diameter, product quantity, number of colors, number of parts, perforation requirements, marking requirements, and packaging requirements. Alternatively, the total variable cost may be calculated based on at least one of a paper cost, waste cost, labor cost, and printing cost.

The total fixed cost is estimated based on at least one fixed cost factor relating to the manufacture of the custom-processed paper product. The at least one fixed cost factor may be one of paper type, paper color, number of colors to be printed, number of parts, perforation requirements, and equipment setup costs.

Also, in accordance with the present invention, the step of generating a quotation includes the step of applying a markup to the cost of manufacturing the custom-processed paper product. Alternatively, the step of generating a quotation includes the steps of selecting a desired mark-up from a plurality of possible markups and applying the selected markup to the cost of manufacturing the custom-processed paper product. The markup is determined based on at least one of a plurality of mark-up factors. The plurality of mark-up factors includes quantity requested, product type, and product features.

The present invention further includes a method for generating a quotation for a custom-processed paper product. The method includes the steps of receiving at least one requirement for a custom-processed paper product from a requester over a network, estimating a cost of manufacturing the custom-processed paper product based at least in part on the at least one requirement, generating a quotation based at least in part on the estimated cost of manufacturing the custom-processed paper product, and communicating the quotation to the requester.

The cost of manufacturing the paper product may be determined by selecting a manufacturer based on a cost quoted by the manufacturer. The at least one requirement may include a first requirement for a first paper product and a second requirement for a second paper product. Further, the step of estimating a cost of manufacturing may include estimating a cost of manufacturing the first and second paper products based at least in part on the first and second requirements, and the step of generating a quotation may include generating a quotation based at least in part on the estimated cost of manufacturing the first and second paper products.

Alternatively, the step of estimating a cost of manufacturing the custom-processed paper product includes the steps of electronically communicating the request to a plurality of potential suppliers, receiving at least one bid from the plurality of potential suppliers, and selecting a desired bid from the at least one bid.

Also, in accordance with the present invention, a method for estimating the cost of a custom-processed paper product for use in a printer application is provided. The method includes the steps of receiving a request for a custom-processed paper product, generating a plurality of estimated costs of manufacturing the requested custom-processed paper product for a plurality of alternative methods of manufacture, determining a plurality of productivity values associated with the alternative methods of manufacture, evaluating each of the estimated costs of manufacturing the requested custom-processed paper product in view of the plurality of productivity values, and selecting a desired cost estimate from the plurality of estimated costs based on the results of the evaluating step.

The custom-processed paper product may be selected from a group consisting of roll, fan-folded, and sheeted material, utilizing thermal, bond, carbonless, and pressure-sensitive label materials. Further, the plurality of alternative methods of manufacture may include a first method involving a narrow format printing press and a second method involving a wide format printing press. Yet further, the desired cost estimate may be determined to be the most cost effective of the plurality of estimated costs.

The present invention also provides a storage medium that includes computer-readable instructions for estimating a cost of manufacturing a paper product, such that the instructions, when executed by a computing device, cause the computing device to process a paper product requirement received over a network, and determine a cost of manufacturing the paper product based at least in part on the requirement.

The present invention further provides a computing device,that includes a storage medium. The storage medium includes instructions that when executed cause the computing device to process a paper product requirement received over a network and determine a cost of manufacturing a paper product based at least in part on the paper product requirement, and a processor coupled to the storage medium to access and execute the instructions.

Additionally, the present invention provides a storage medium that includes a computer-readable data structure for storing data relating to a cost estimate for a paper product. The data structure includes a first database comprising data representing estimator values, a second database comprising data representing paper types, and a third database comprising data representing pricing information.

Additional features of the invention will become apparent to those skilled in the art upon consideration of the following detailed description of illustrated embodiments exemplifying the best mode of carrying out the invention as presently perceived.

### BRIEF DESCRIPTION OF THE DRAWINGS

The detailed description particularly refers to the accompanying figures in which:

FIG. 1 is a block diagram of an exemplary system for implementing the method and apparatus of the present invention;

FIG. 2 is a flow diagram for a method for providing a quotation according to the present invention;

FIG. 3 is a flow diagram for an alternative method for providing a quotation according to the present invention;

FIG. 4 is a flow diagram for a method for generating a quotation according to the present invention;

FIG. 5 is a flow diagram for a method of determining variable cost according to the present invention;

FIG. 6 is a flow diagram for a method of determining fixed cost according to the present invention;

FIG. 7 is an exemplary input screen for paper product information in accordance with the present invention; and

FIG. 8 is an exemplary display of a quotation for a paper product in accordance with the present invention.

### DETAILED DESCRIPTION OF THE DRAWINGS

The present invention provides online quotations for custom-processed paper products as well as stock paper products. The present invention includes an online estimating system. The present invention also includes a paper product selection mechanism. The online estimating capabilities and other aspects of the present invention significantly improve the process of providing a quotation for a custom-processed paper product.

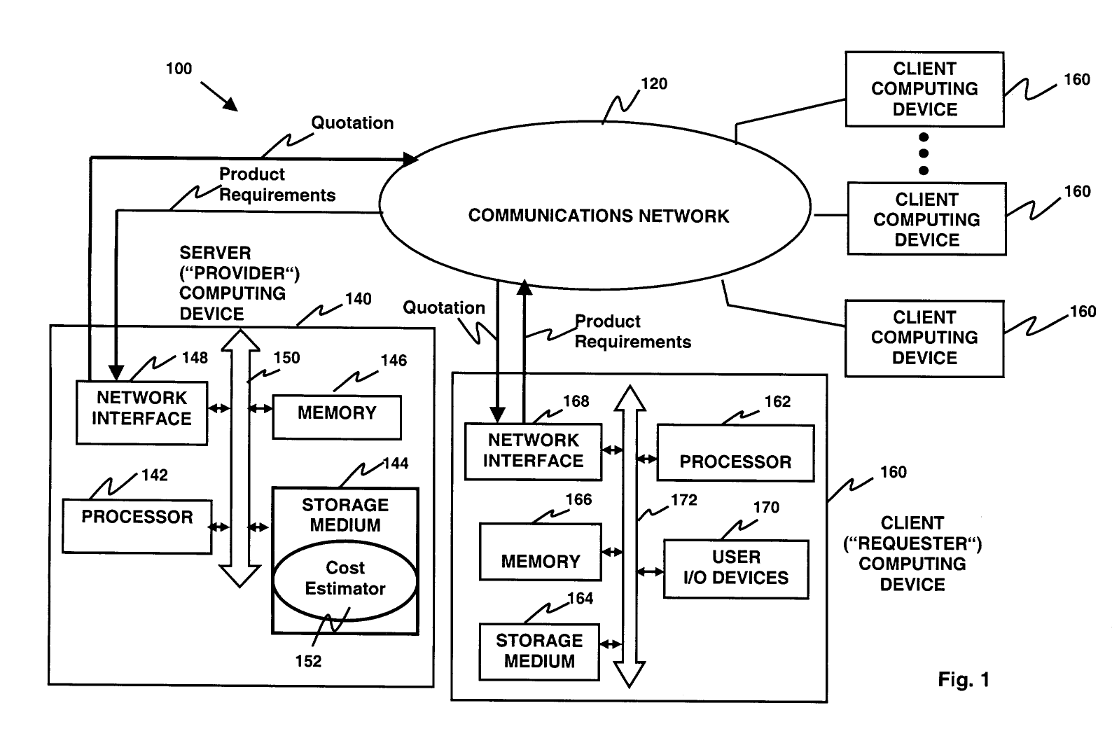

Referring now to the drawings, FIG. 1 is a block diagram of an exemplary system 100 for providing a quotation for a paper product according to the present invention. In the illustrated embodiment, the system 100 is configured in a “client/server” (or “two-tier”) architecture. Accordingly, the system 100 includes a communications network 120, a server computing device 140, and at least one of a plurality of client computing devices 160. Although the exemplary system 100 is implemented in a client/server architecture, it should be appreciated that alternative embodiments may be implemented, for example, in a peer-to-peer architecture or any other suitable configuration.

The communications network 120 operably couples the server computing device 140 to at least one of the plurality of client computing devices 160 such that the server computing device 140 and at least one of the plurality of client computing devices 160 may exchange information in accordance with the present invention. The communications network 120 is the Internet, the World Wide Web, a local area network, wide area network and/or any other suitable collection of devices that are connected to share information. Additionally, it is noted that the communications network 120 may include a hardwired telephone network, a wireless telephone network, a cable network, and/or a satellite network.

The server computing device 140 may alternatively, or in addition, include a single computing device or a plurality of networked computing devices. In the exemplary embodiment of FIG. 1, the server computing device 140 includes a processor 142, a storage medium 144, memory 146, a network interface 148, and a system bus 150. The processor 142 is generally operable to obtain software and/or firmware programming instructions (including cost estimator 152) from the storage device 144, load the instructions into memory 146, and execute the instructions from memory 146.

As a result of executing the instructions read from memory 146, the processor 142 controls the general operation of the server computing device 140.

The storage medium 144 typically includes non-volatile memory and is generally operable to store data and/or software instructions for the server computing device 140. To this end, the storage device 144 is any suitable computer readable and/or writeable media device. The storage medium 144 may include multiple such devices and may be distributed among several computing devices. In the exemplary embodiment, the server computing device 140 transmits and receives information over the Internet according to the HyperText Transfer Protocol (“HTTP”) and the Transmission Control Protocol/Internet Protocol (“TCP/IP”) network protocol. It is noted, however, that any other suitable transfer protocol or any network protocol may be used in addition to or instead of instructions for the HTTP protocol and the TCP/IP protocol.

Memory 146 stores data and instructions used by the processor 142. To this end, memory 146 includes standard random access memory for storing the data and programming instructions needed by the processor 142. Alternatively, memory 146 may include any other volatile and/or non-volatile memory suitable for storing data and software or firmware instructions.

The network interface 148 operably couples the server computing device 140 to the communications network 120 such that the server computing device 140 may communicate with the at least one of the plurality of client computing devices that are also operably coupled to the communications network 120. The system bus 150 is generally operable to interconnect the processor 142, the storage medium 144, memory 146, and the network interface 148, and to enable these components of the server computing device 140 to communicate with one another.

It is noted that the above described components of the server computing device 140 are merely exemplary, and in alternative embodiments those skilled in the art may elect to replace all or portions of these components with suitable discrete analog circuit components, discrete digital circuit components, integrated analog circuits, integrated digital circuits, and/or integrated analog/digital hybrid circuits without undue experimentation.

The one or more client computing devices 160 included in the system 100 are configured and coupled to the communications network 120. In general, the client computing devices 160 are implemented using a personal computer system, a desktop computer system, a computing workstation, a handheld computing device, and/or any other suitable network-enabled (preferably Internet-enabled) computing device. In the exemplary embodiment, the client computing devices 160 includes a processor 162, a storage medium 164, memory 166, a network interface 168, one or more user I/O devices 170, and a system bus 172.

The processor 162 is generally operable to obtain software and/or firmware programming instructions from the storage medium 164, load the instructions into memory 166, and execute the instructions from memory 166. As a result of executing the instructions read from memory 166, the processor 162 controls the general operation of the client computing devices 160. The storage medium 164 is generally operable to store data and/or programming instructions for the client computing device 160. The storage medium 164 includes any suitable computer readable and/or writeable storage media. Additionally, the storage medium 164 may include multiple storage media and/or may be distributed among several such media.

In the illustrated embodiment, the programming instructions stored on client devices 160 include web browser software or other suitable instructions or programs that enable the client computing devices 160 to access information and programs located on remote systems, including the server computing device 140.

Memory 166 stores data and programming instructions used by the processor 162. Memory 166 generally includes standard random access memory for storing the data and instructions needed by the processor 162. Alternatively, memory 166 may include any other volatile and/or non-volatile memory suitable for storing data and software or firmware instructions.

It is noted that the client computing devices 160 may alternatively be implemented with memory chips and/or other suitable hardware such that the same hardware implements both the storage device 164 and memory 166. Many handheld computing devices (e.g. Palm Pilots), Internet-enabled cellular phones, and other special purpose computing devices are implemented in such a manner. It will be readily appreciated that any such device may be used to implement one or more of the client computing devices 160.

It is further noted that server computing device 140 may also act as a client computing device 160 in an alternative embodiment. In other words, the programming instructions implemented on server 140 in accordance with the present invention may be accessed directly via an I/O device connected to the server 140 (not shown).

In the illustrated embodiment, the network interface 168 operably couples the client computing devices 160 to the communications network 120 such that the client computing devices 160 may communicate with the server computing device 140 via the communications network 120. In the illustrated embodiment, the network interface 168 comprises an analog modem for use over telephone lines, or a digital modem such as a cable modem for use over a cable distribution network. Alternatively, or in addition, the network interface 168 may include a network interface controller that can be used to connect the client computing devices 160 to the communications network 120.

The client computing devices 160 also include one or more user I/O devices 170. In general, the user I/O devices 170 provide a user of the client computing device 160 (e.g., a requester) with mechanisms for inputting information into the client computing device 160, receiving information from the client computing device 160, and/or controlling the operation of the client computing device 160. The user I/O devices 170 include suitable monitors, screens, or other visual display devices known in the art and/or other output devices that are operable to visually present information to a user of the exemplary client computing device 160. The user I/O devices 170 may also include audio devices that are used to audibly present information to a user of a client computing device 160. Further, the user I/O devices 170 include a mouse, a keyboard, a touch pad, a push button, a scanner, a stylus, a touch screen, and/or other suitable input devices that provide a user of a client computing device 160 with an interface to directly control the operation of the client computing device 160 and/or indirectly control the operation of the server computing device 140.

The system bus 172 is generally operable to enable the various components of the client computing devices 160 to communicate with one another. The system bus 172 is implemented with any suitable bus architecture(s) known in the art. In the exemplary embodiment, the system bus 172 interconnects the processor 162, the storage device 164, memory 166, the network interface 168, and the user I/O devices 170.

It is noted that the above described components of the client computing devices 160 are merely exemplary, and in other embodiments those skilled in the art may elect to replace all or portions of these components with suitable alternatives without undue experimentation.

As shown in FIG. 1, in accordance with the present invention, a requester uses a client computing device 160 to communicate product requirements, i.e., specifications or characteristics of desired paper products, to a provider's server 140 via network interface 168 over communications network 120. The provider is, for example, a supplier or manufacturer, or an entity that custom-processes paper products, or an entity that processes custom paper product orders. The requesters of paper products are, for example, dealers and distributors of stock and/or custom-processed paper products.

Server 140 receives the requester's product requirements via network interface 148. Server 140 executes programming logic including cost estimator 152 to process the received requirements and generate a quotation for the requester. Cost estimator 152 is described in greater detail below. Server 140 communicates the quotation to the requester's client device 160, via communications network 120.

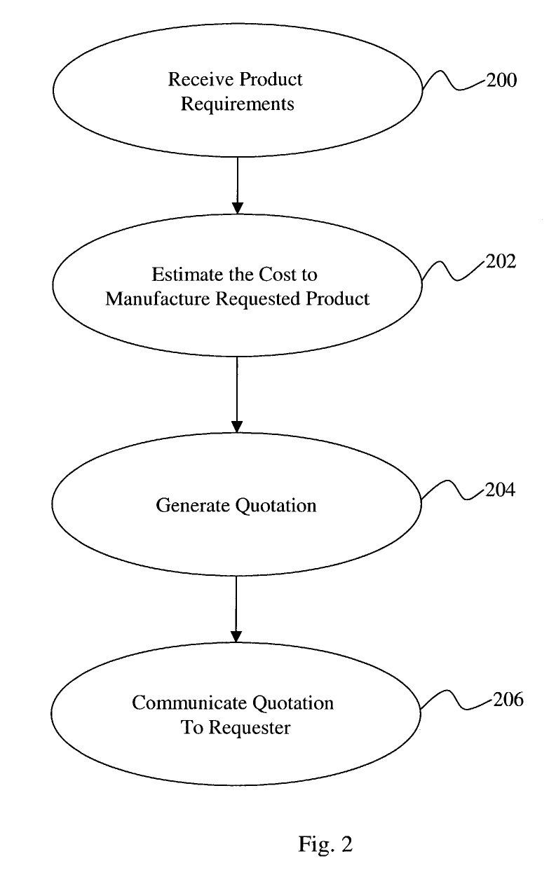

FIG. 2 shows a flow diagram for a method for providing a quotation for a paper product to a requester in accordance with the present invention. At step 200, a server device 140 receives, via network 120, a request for a quotation including one or a plurality of requirements for a paper product from a requester using a client computing device 160. These requirements may include paper type, thickness, dimensions, and/or quality, colors to be printed, printing requirements, requester's machine type (e.g., make, model), delivery requirements, and any other information pertinent to the request.

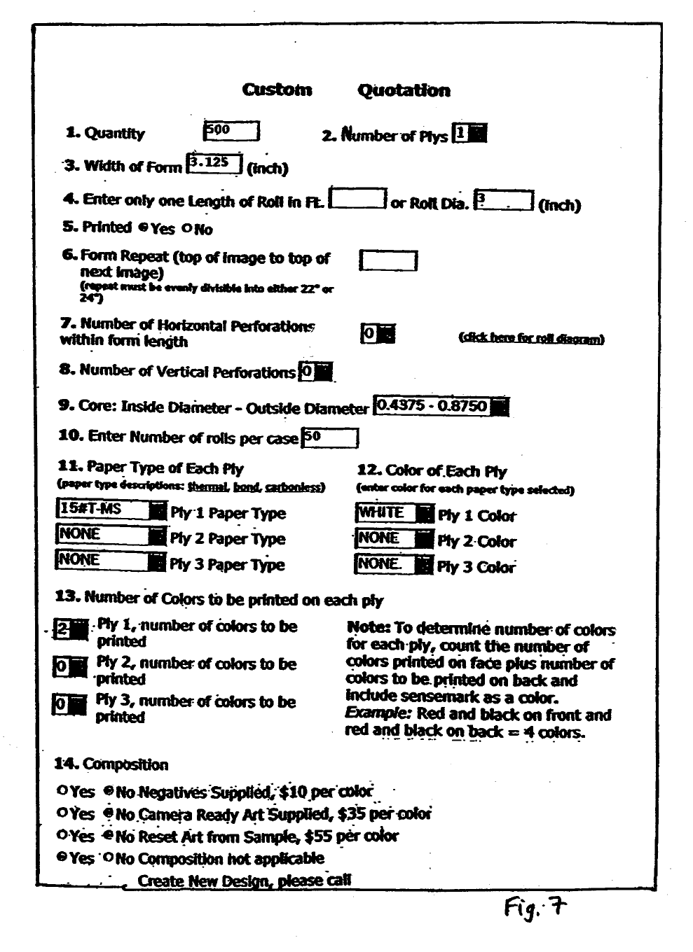

FIG. 7 shows an exemplary display screen for the input of product requirements. A screen such as is shown in FIG. 7 is displayed to the requester via an I/O device 170. The requested product information may be obtained from the requester in a variety of ways known in the art, e.g., via keyboard data entry, electronic stylus, touch-screen, voice input, or other suitable input method known in the art. Further, as shown in FIG. 7, the requester may specify the requested information by freely inputting it; alternatively or additionally, the requested information may be automatically or manually selected from a database, table, spreadsheet or list of possible choices.

In the illustrated embodiment, programming instructions are used to perform cross-referencing to determine when certain data input by a requester is incorrect or redundant based on other information already input by the requester or information already known to the system from predefined look-up tables, spreadsheets, lists or databases. For example, the provider's database includes industry-wide information relating to the types of equipment used by various possible requesters in the industry. This portion of the database is used to validate information input by a requester. The exemplary display of FIG. 7 is discussed in further detail below.

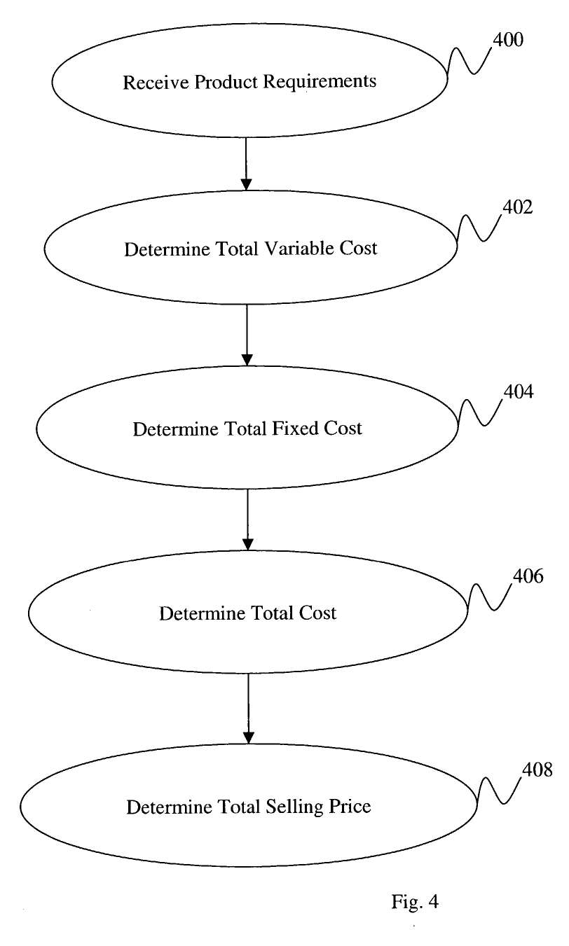

At step 202, server computing device 140 executes programming logic including cost estimator 152 to estimate a cost of providing the requested product to the requester. Details relating to the operation of cost estimator 152 are discussed below, in connection with the discussion of FIGS. 4-6.

A quotation indicating the price of the requested product offered to the requester is generated at step 204. In the illustrated embodiment, the price is determined by applying a markup to the product cost determined at step 202. In the illustrated embodiment, a markup is determined based on the quantity of products requested. For example, a markup may be a percentage, which is multiplied by the estimated cost. The product of this calculation is then added to the estimated cost in order to generate the final selling price. The markup may also be a fixed dollar value that is added to the estimated cost. The markup may be obtained from a predefined look-up table, list, spreadsheet, or database. It is understood that the markup may be determined based on factors other than quantity. For example, the markup may be unique to each requester. Markups may also be determined wholly or in part based on the product type, product features, requester's geographic location, the total cost of the order, the urgency of the order, the uniqueness of the request, and/or other factors deemed relevant by the provider.

Delivery and/or shipping terms may also be factored into the quotation, although the quotation may be provided with or without shipping. For example, “next day”, “second day”, “three day”, “ground”, “truck” or other shipment method may be specified for delivery of the requested paper products. Also, the requester may specify if the order would be a “rush” order; in which case the manufacturer would commit to fill the order within a predefined shortened period, e.g., ten days, for an additional fee. The cost of the selected shipment method and carrier are automatically factored into the quotation. Alternatively or in addition, the requester's geographic location is used to determine shipment costs. For example, in the illustrated embodiment, the requester inputs the zip code (or other location-identifying information) for the destination of the requested product. The cost of shipment to the specified destination is calculated, e.g., with reference to a look-up table, list, spreadsheet or database of cost and location information, based on the zip code or other location indicator, and added to the price quoted to the requester. In addition, freight costs may be calculated and added to the quotation. In the illustrated embodiment, freight is calculated by reference to the weight of the requested product using a predefined look-up table, list, database, or spreadsheet of freight cost values. For example, either a UPS zone chart or LTL truck rate chart (based on market LTL rates) may be used. Further, programming logic is used to determine whether the selected delivery method is appropriate given the size and specifications of the requester's order. For example, if “truck” is selected, programming logic is used to make sure that the weight of the requested product to be shipped by truck is sufficient (i.e., greater than a predetermined threshold) for delivery by truck.

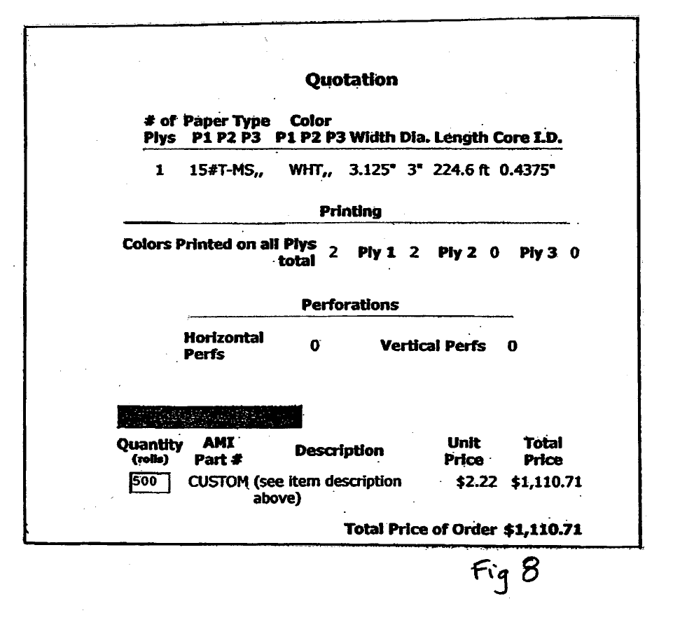

FIG. 8 shows an exemplary quotation for a requested product. The unit price reflects the markup. The total price is the unit price multiplied by the quantity requested. The specific aspects of the exemplary quotation will be discussed further below.

The quotation generated at step 204 is communicated to the requester via communications network 120, at step 206. A visual or audible signal may be provided in connection with the quotation to alert the requester that the quotation has arrived at a client computing device 160. Illustratively, the quotation is generated in real time, while the requester remains online, because the time between the requester's submission of a request and the delivery of a quotation is a matter of seconds, i.e., nearly instantaneously. However, it is also within the scope of the present invention to allow the requester to submit one or multiple requests for quotations at a given time, and then return later to access the quotations. A unique identifier is assigned to each quotation so that a requester may access or recall a particular quotation as needed. In another embodiment, the quotation is sent to the requester via e-mail when completed.

The quotation may be encrypted or otherwise protected from unauthorized access. Additional programming, equipment or devices may be employed to verify that the quotation is sent to the correct requester, to prevent the quotation from being retransmitted by the requester to an unauthorized party, and/or to permit the requester to retransmit the quotation to an authorized party, in accordance with suitable techniques known in the art. For example, the requester may be permitted to electronically forward the quotation to its customer. Alternatively, the requester may be permitted to electronically authorize the provider to automatically forward the quotation to the requester's customer.

Further, in another embodiment, programming logic is implemented to permit the requester to store the quotation for a limited or unlimited period of time in a storage medium either on server 140 or on client device 160. In such embodiment, the requester is permitted to “recall” the stored quotation upon accessing the application of the present invention, or the stored quotation is automatically displayed to the requester upon successful login.

Yet further, once a quotation is communicated to the requester, the requester may electronically place an order for the requested products, e.g., directly from the display of the quotation. Such ordering capability may be provided whether the quotation is newly generated or is a saved quotation that the requester has recalled for further review. If an order is submitted, an electronic receipt including a unique order confirmation number is generated and communicated to the requester.

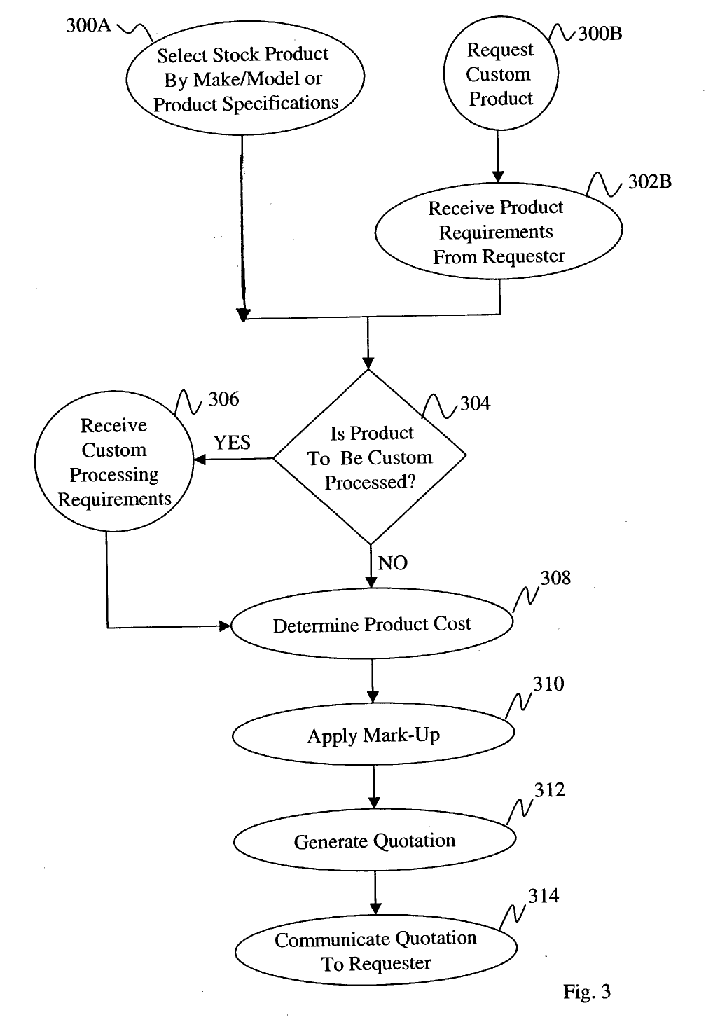

FIG. 3 shows a flow diagram for alternative methods for providing a quotation for a paper product to a requester. As shown in FIG. 3, a requester may either select a stock item or a custom product.

If the requester desires a quotation on a stock item, step 300A is performed. At step 300A, the requester is prompted to select a stock item either by choosing the make and/or model of the machine in which the stock item is to be used, or by providing product specifications, such as paper type and width. As an example, a requester who knows that he or she needs automatic teller machine (ATM) receipt paper for an NCR-brand ATM model number 5670 would select “NCR ATM 5670” from a pull-down list of possible machine make and model choices. If the requester does not know the machine, but knows other product specifications, the requester would input the known specifications, e.g., paper type=“thermal”, width =3.125 inches. The machine make and model or product specifications are communicated to server 140 via communications network 120.

As an alternative to steps 300A, the illustrated embodiment provides a facility that permits a requester to obtain a quotation on a non-stock item, or custom product. At step 300B, the requester is prompted to input requirements for a custom product via a user I/O device 170, for example, a paper grade, core diameter (for roll products), perforation, specifications, special packaging requirements, such as quantity per case. A provider server 140 receives these requirements for one or more products from a requester via communications network 120 at step 302B.

It is possible that the requester desires a stock item or a custom-processed product to be custom printed or otherwise custom processed. At step 304, the requester is prompted to indicate whether the requested product is to be custom printed or otherwise processed. If the requested product is to be custom printed or processed, then at step 306, the requester is prompted to provide the requirements for custom printing or processing. Custom printing or processing requirements may include, for example, if the product is to be custom printed, the number of colors to be printed and number of plys. The number of colors to be printed is determined by adding together the total number of colors to be printed on each side of the paper product. For example, if red and black are to be printed on the front side and blue and green are to be printed on the back side of the paper product, the number of colors is four.

At step 308, programming logic executed at server 140 determines the cost of providing the requested product (including custom printing or processing costs, if necessary) based on the product requirements obtained as described above, to the requester. If the requested product is a stock item, the product cost is determined by identifying potential suppliers of the stock item and selecting a supplier who has submitted the most desirable (i.e., lowest-priced) bid to provide the item to the requester. In one embodiment, the provider contacts the potential suppliers electronically via network 120 in real time (e.g., by e-mail, instant messaging, or other suitable method), the potential suppliers submit bids to the provider electronically, and the provider electronically accepts the lowest or otherwise most desirable bid (e.g., according to predefined acceptance criteria). In an alternative embodiment, a database, table, list, or spreadsheet of potential suppliers and their respective bids, price lists, or pricing schemes are maintained by server 140, in which case programming logic is used to select the supplier with the lowest or otherwise most preferable bid or price for the requested product from the database.

If the requested product is a custom product, or requires custom printing or processing, the product cost is estimated as described further below. Cost estimator 152 is executed to determine the estimated cost to provide the custom or custom-processed product to the requester. For example, the following inputs may be used to determine the estimated cost: quantity, number of plys, form width, roll length and/or diameter, number of horizontal perforations (if any), number of vertical perforations (if any), number of colors to be printed on each ply, core diameter, number of rolls per case, paper type of each ply, and any specified composition requirements (such as whether art work is to be incorporated, and if so, the type of art work). Cost estimator 152 is described further below.

At step 310, an appropriate markup is added to the cost of the item as described above. The quotation is generated at step 312. If the requester selected a particular shipping option, shipping charges are added to the marked-up product cost and included in the quotation. The finished quotation is communicated to the requester at step 314.

If the requested product does not require custom processing, then step 306 is ignored and steps 308, 310, and 312 are performed to generate a quotation. At step 314, the generated quotation is communicated to the requester via network 120 as described above.

FIG. 4 shows a flow diagram for a method for generating a custom product or custom-processed price quote based on requirements for a requested product, implemented in the illustrated embodiment as cost estimator 152. At step 400, server 140 receives requirements for a custom product or custom-processed product from a requester via communications network 120.

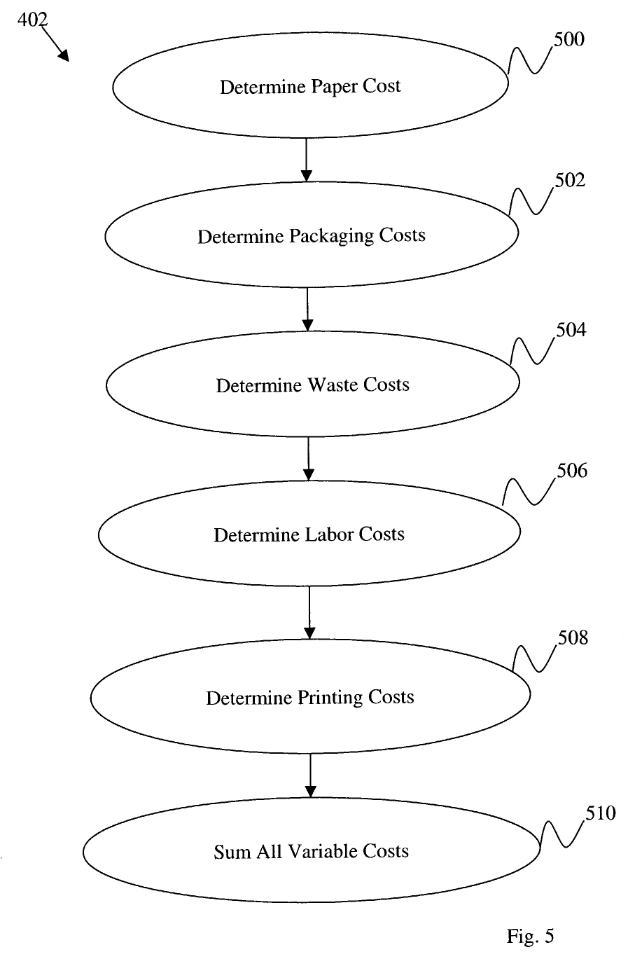

Steps 402, 404, and 406 are performed to determine the total estimated cost of the requested product. At step 402, server 140 executes programming logic to identify at least one variable cost factor related to at least one of the product requirements received from the requester. For each such cost factor, an estimated cost is determined. The estimated cost of each cost factor is determined according to a predefined mathematical formula or algorithm, or, alternatively, obtained from a “look-up” table, list, database, spreadsheet, or other structure that stores cost factors and their corresponding estimated costs. The identification of variable cost factors and calculation of variable costs is discussed in more detail in connection with FIG. 5, below. The variable costs for all of the identified variable cost factors are summed to produce the total variable cost.

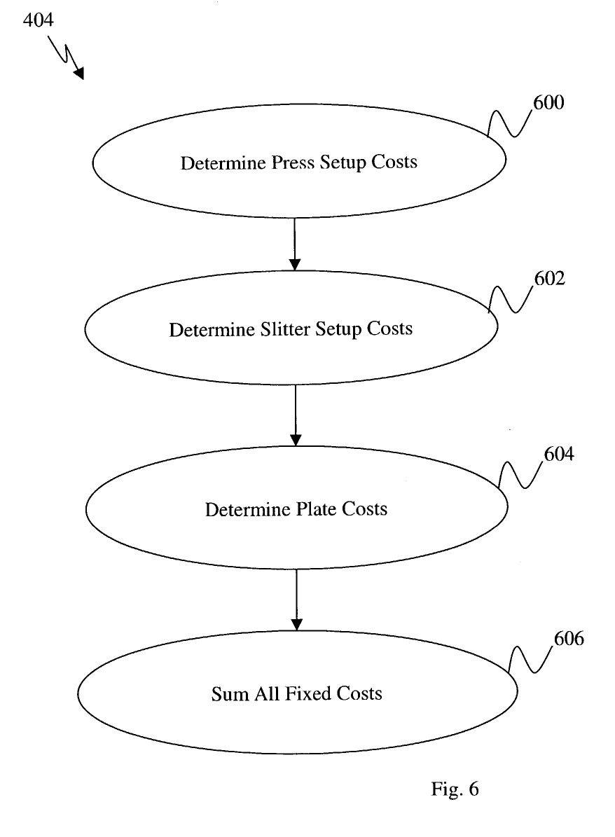

At step 404, a similar procedure is followed to determine the total fixed cost of the requested product. Programming logic determines the fixed cost factors related to the requirements of the requested product. The estimated cost of each fixed cost factor is determined, and the estimated costs are summed to produce the total fixed cost of the requested product. The identification of the fixed cost factors and calculation of total fixed cost is discussed further in connection with FIG. 6, below. It is understood that the present invention does not require steps 402 and 404 to be performed in any particular order, i.e., total fixed cost may be calculated before total variable cost, or total fixed cost and total variable cost may be calculated simultaneously.

The total variable cost calculated at step 402 and the total fixed cost calculated at step 404 for the requested product are added together at step 406 to produce the total estimated cost of the requested product. At step 408, a markup is applied to the total estimated cost as described above to generate the total selling price. In an alternative embodiment, shipping or delivery costs are included in the total selling price, also as described above.

FIG. 5 shows a flow diagram for a method for calculating a variable cost of a requested paper product in accordance with step 402 of FIG. 4. A variety of cost factors may be considered in determining the variable cost of a requested product. The relevant cost factors are determined at least in part by programming logic analyzing the product requirements input by the requester. In the embodiment of FIG. 5, steps for identifying paper, packaging, waste, labor and printing cost factors and determining the associated costs are shown. The costs associated with each cost factor are illustratively determined using programming logic and/or a look-up table, list, database or spreadsheet that provides cost information for the various cost factors. It is understood that the cost factors may be identified and determined in any order; i.e., even though FIG. 5 shows determining paper costs as the first step 500, the present invention does not require steps 500, 502, 504, 506, and 508 to be performed sequentially or in any particular order.

At step 500, the cost of the paper used in the requested paper product is determined. The requirements received from the requester may specify a certain paper type, or the required paper type for the requested product may be determined using programming logic (e.g., by accessing a look-up table). Factors in addition to paper type that influence the paper cost are identified based on the product requirements. For example, the quantity of products requested affects the amount of paper required to produce the requested product. The amount of paper required is determined by the dimensions of the required paper. For example, if rolls of paper are to be used, the roll length, width, and core diameter, as well as the paper thickness, are all factors that are used to determine the quantity (e.g., number of square feet or linear feet) of paper needed for the job. As implemented in cost estimator 152, roll length is used to determine paper cost; if roll length is not provided, it is calculated using the roll diameter, core diameter and paper thickness. These factors are obtained either from the requester or from a look-up table based on the paper type. Once the quantity of paper required is determined, the paper cost is calculated by multiplying the quantity by the unit cost (e.g., cost per square foot).

At step 502, packaging costs are determined. Packaging costs are the costs of packaging the requested product. Packaging costs include the cost of the boxes (e.g., corrugated cardboard) or other containers used to hold the requested product, as well as the cost of the paper roll cores (if any). The cost of the paper roll cores depends on the size of the core, the roll width of the finished product, and the number of rolls needed for the finished product. In the illustrated embodiment, the core cost is obtained from a lookup table based on the size of the core, and multiplied by the finished roll width and the number of rolls used to determine the total core cost.

In paper product processing jobs, a certain amount of waste occurs. For example, if a paper processing job requires color printing, test paper will need to be printed before the job is run. Thus, certain “waste costs” are considered when estimating the total variable cost of a paper product. These waste costs are determined based on the requirements of the requested product at step 504. Waste cost factors include, for example, trim waste, press run waste, and slitter run waste. The amount of trim waste produced by processing the requested product is the amount of paper that needs to be trimmed from the mill roll in order to complete the requested product. In the illustrated embodiment, the trim waste is determined by comparing the roll width of the paper mill roll to the finished roll width. The cost of the trim waste is then calculated by multiplying the unit paper cost (e.g., cost per square foot) by the amount of trim waste produced by the job.

Press run waste is the amount of wasted paper produced during the printing press run for the requested product. An estimated amount of press run waste is calculated based on the number of colors to be printed (if any), and the number of perforations required. The estimated press run waste factor is multiplied by the unit paper cost to determine the estimated press run waste cost.

Slitter run waste is the amount of wasted paper produced during a run of the manufacturer's slitter machine. The slitter machine is used, for example, if the requested paper product is a rolled product. The estimated amount of slitter run waste is multiplied by the unit paper cost to determine the estimated slitter run waste cost.

The trim waste, press run waste, and slitter run waste costs are added together to determine the total waste cost at step 504.

When paper products require special processing, the provider incurs a certain amount of labor costs, for example, labor is required to convert paper on a slitter machine to a specific configuration for a requested rolled product. These labor costs are factored into the total variable cost of the requested product. They are determined based on the product requirements, at step 508. The labor costs are calculated by first estimating the number of hours of labor required and then multiplying the number of hours by the applicable hourly labor rate. The number of hours of labor required is estimated based on the quantity of product to be produced and the amount of product that can be produced per hour. In the illustrated embodiment, production rates are maintained in a database for look-up, based on the product requirements. For example, production rates for roll products are based on the roll length. If a roll product is 300 feet in length, the production rate is determined based on how long it takes to produce that roll length. A roll product with a length of 100 feet will have a different production rate than the product with a 300-foot roll length.

In addition, certain additional costs associated with custom-printed paper products are factored into the total variable cost. Such “printing costs” include, for example, printing press run time costs and ink costs. These costs are included in the variable cost estimate for the requested paper product, and are calculated at step 510. Printing press run time costs are calculated if the requested product requires printing. These costs are determined based on the amount of paper required to process the request (e.g., linear feet) and the processing rate of the printing press (e.g., linear feet per minute) multiplied by the cost to run the press (e.g., rate per minute). The estimated ink costs depend on the number of colors to be printed. In the illustrated embodiment, the number of colors to be printed is multiplied by an estimated cost per color.

All of the variable costs relating to the cost factors determined to be relevant to the requested product based on the product requirements are added together at step 510 to determine the total variable cost of the requested product.

FIG. 6 shows a flow diagram for a method for calculating a fixed cost of a requested paper product in accordance with step 404 of FIG. 4. A variety of cost factors may be considered in determining the fixed cost of a requested product. The relevant cost factors are determined at least in part by programming logic analyzing the product requirements input by the requester. In the embodiment of FIG. 6, press, slitter, and plate cost factors are shown. The costs associated with each cost factor are determined using programming logic and/or a look-up table, list, database or spreadsheet that correlates cost information with each of the various cost factors. It is understood that these cost factors may be identified and determined in any order; i.e., even though FIG. 6 shows determining press setup costs as the first step 600, the present invention does not require steps 600, 602, and 604 to be performed sequentially or in any particular order.

At step 600, the cost of setting up the printing press(es) is determined, if the product requirements indicate that the requested paper product is to be printed. For example, press setup costs include fixed costs to set up the printing press for each color to be printed, as well as a fixed “waste” cost based on the number of linear feet of paper that must be used in order to set up each color to be printed. The press setup cost may be a predetermined value obtained, e.g., from a look-up table or database based on the particular printing press required for the printing job, or may be a calculated value. In the illustrated embodiment, the press setup cost is a calculated value that depends on the paper type, the number of colors to be printed and the number of perforations required. If no colors are to be printed and/or perforations are not required, then these cost factors will be ignored in calculating the press setup costs.

The press setup waste cost for the requested product may be a predetermined value obtained, e.g., from a look-up table or database, or it may be a calculated value. In the illustrated embodiment, the press setup waste cost is based on the paper type, the size (e.g., width) of the paper mill roll, the paper cost for the required paper type, the number of colors to be printed (if any), and the number of perforations (if any). The paper cost is obtained from a look-up table or database based on the required paper type. The paper cost may be specified as a cost per unit of paper, e.g., cost per square foot. In this case, the quantity of paper required to process the requested product is determined and the unit paper cost is multiplied by such quantity to determine the total paper cost of the job. The mill roll width may vary depending upon whether or not printing is required.

Similarly, the cost of setting up the slitter machine(s) is determined at step 602, if the requested product requirements indicate that the slitter machine needs to be used. In the illustrated embodiment, a fixed cost to set up a slitter is determined based on the make and/or model of the slitter machine to be used for the job. The slitter model to be used may depend on the product requirements, or may depend on the manufacturer and the type of slitter equipment the manufacturer has on hand.

At step 604, the cost of the printing plates required to be used to complete the processing of the requested paper product is determined, if the paper product is to be printed. This cost will depend on the number of colors to be printed. For example, the total plate cost is the number of colors multiplied by the cost of each color print plate. The plate cost is typically a constant value obtained from a look-up table or database.

The above-mentioned fixed costs are added together at step 606 to produce a total fixed cost for the requested product.

FIGS. 7 and 8 show exemplary screen displays shown to a requester via client device 160 during execution of the above-described methods.

In accordance with the present invention, a requester places a request for a paper product quotation via client devices 160 by using a web browser or other suitable means to access a software application embodying the present invention stored on a provider's server 140, over the communications network 120. For security reasons, the prospective user is prompted to input a user name and password. Additionally or alternatively, additional means of providing security to the application and/or the information transmitted thereby over network 120 may be provided as is known in the art.

After a requester successfully gains access to the provider's application, the requester inputs information relating to one or more products using client computing devices 160, for example, in response to prompts for information displayed on an I/O device 170. As described above, if the requester desires a quotation for a stock item, the user may search a database of stock items by selecting the desired item or type of item (e.g., paper, printer ribbon, envelope, label, etc.), from a list of possible choices. If the requester does not know the specific product needed (e.g., by part number), but knows the make and/or model of the machine in which the paper product is to be used (e.g., a cash register, fax machine, printer, copier, etc.), the requester may input or select the machine make and/or model. In such case, programming logic executed by screen 140 determines one or more products suitable for use with the specified machine make and/or model.

Alternatively or in addition, the requester may select a product for quotation by inputting requirements or specifications to identify or describe the desired product, for example: paper type (e.g., bond, carbonless, etc.), paper color, number of parts, paper width, diameter, length, core I.D., and/or number of parts or part number. In the illustrated embodiment, paper dimensions may be input in either English or metric units of measure. Further, if the requested paper product is a custom product or requires custom processing, the number of colors, required perforation, any special markings or graphics required, and particular packaging requirements are input.

As mentioned above, FIG. 7 shows an exemplary input screen whereby a requester provides information relating to a custom paper product for which the requester desires the provider to provide the quotation. A custom paper product may be any paper product that requires custom processing, including stock items that are to be custom-printed, as well as paper products that are otherwise customized for a particular requester, for example, as to dimensions, paper type, perforations, and/or composition. In FIG. 7, the requester inputs the quantity of product requested at input item 1. In certain instances, information may be automatically filled in at the appropriate input areas on the display screen by programming logic, based on information already input by the requester or information already known to the software application, for example from a look-up table, database, list, or spreadsheet. For example, if the paper type is “thermal,” the color selection is automatically “white.”

The remaining specifications for the requested custom product are provided at the appropriate locations as shown in FIG. 7. The number of plys is provided at input item 2. The width of the media (i.e., any type of paper or label material) is provided at input item 3 and the specifications for repeating the media are provided at input item 6. The roll length or diameter is provided at input item 4, the core diameter information is provided at input item 9, and the number of rolls per case is provided at input item 10, if the requested product is a paper roll. For custom products, the requester may specify the quantity of product it wants per case. Thus, cases may be requested in a variety of sizes, for example, depending on how the requester displays the product to customers, or the space available for display or stocking. If roll diameter is provided, the cost estimator 152 will calculate roll length based on a formula which uses roll diameter, core O.D., paper thickness, and a constant value.

If the requested product is to be perforated, the number of horizontal perforations and the number of vertical perforations are provided at items 7 and 8. If the requested product is to be printed, an indicator of such is selected at item 5, the colors and number of colors to be printed on each ply are specified at input items 12 and 13, and the applicable composition requirements are provided at input item 14. Composition requirements are provided if graphics are to be printed on the paper product. As shown in FIG. 7, the requester is prompted to select the appropriate composition option based on how artwork will be provided to the manufacturer (e.g., negatives, camera-ready art, electronic images, etc.). Specifications for the paper type or types (if multiple plys) are provided at input item 11. It is understood that each of the input items may be implemented graphically on a display screen by text boxes, radio buttons, pull-down or drop-down lists, or other suitable input mechanisms known in the art.

Once the requester has selected or defined a product to be quoted, programming instructions on server 140 process the product requirements and generate a quotation using cost estimator 152.

The custom estimating feature of the present invention calculates the cost to manufacture a custom-processed paper product based on the inputted specifications. The cost estimator 152 uses the requester's inputs, certain constant values, and a set of formulas as described above to calculate the total cost to manufacture the requested item as described above. The calculations performed by the cost estimator 152 may be implemented using programming logic and/or commercially available spreadsheet software.

The present invention also includes a “smart estimator” capability that permits more accurate cost estimation. In accordance with this feature, cost estimator 152 includes programming logic that analyzes certain of the requirements of the requested product to determine the most cost-effective method of production of the requested product. For example, the requested product quantity, order size, number of colors to be printed, repeat size, and/or other requirements are considered as additional cost factors affecting the cost estimating calculations described above. Further, additional cost factors may be included relating to the product supplier's specific capabilities and/or cost structure. Thus, it is contemplated that cost estimator 152 may include cost factors relating to the requested product's requirements, the requester, and/or the product supplier.

For example, it may be more cost-effective to produce a printed order of 100 cartons of cash register rolls with one color logo on a wide format printing press than on a narrow format printing press. The cost estimator 152 compares the setup costs and productivity rates of the wide format printing press and the narrow format printing press to determine which press would be more cost-effective. In this example, the setup cost for the wide format press is $500 while the narrow format press has a setup cost of only $50. However, the productivity rate for the wide format press is three times greater than the narrow format press. Hence, the narrow format press will be more efficient for smaller orders, while the wide format press will be more efficient for larger quantity orders. In “smart estimator” mode, the cost estimator 152 calculates at what point the higher set up costs of the wide format press are offset by increase in productivity. In other words, smart estimator 152 includes programming logic that compares the unit setup cost per case or carton of product if produced on alternative equipment, based on the total quantity of product requested in view of the productivity of the equipment used. Equipment productivity rates and setup costs are obtained from predefined look-up tables, spreadsheets, lists or databases.

In accordance with the present invention, an appropriate markup is applied to the cost for the requested item, as described above. The resulting quotation is communicated to the requester, for example as shown in FIG. 8. The exemplary quotation shown in FIG. 8 displays an identifier of the requested product (e.g., part number), along with the requested specifications (e.g., number of plys, colors, paper/roll dimensions), and shows the unit price (e.g., per roll) and the total price for the quantity requested.

It is contemplated that upon receiving the quotation, the requester may change any of the product requirements (such as quantity, part number, shipping requirements, etc.) to generate a new quotation, save the quotation for later review, or electronically place an order for the quoted product. For example, the requester may vary the quantity to determine the quantity at which a price break occurs.

If the requester desires to accept the quotation and place an order, the necessary order details are transmitted to the provider and/or directly to the supplier who provided the quote. For stock items, the order identifies the lowest cost supplier of the ordered item(s) found in the database as well as the supplier's price. Thus, the requester or the provider may then place the order with most cost-effective supplier. In the illustrated embodiment, if only the quantity is changed, the quotation is updated without the requester having to re-input all of the other product requirements.

In addition, the present invention includes a “combo pricing” feature in which a quotation is generated for multiple similar products at once. If a requester requests multiple products that are similar, but the only difference is in the printing (i.e., what is printed on each product), then the quantities of all of the products are added together and the quotation is generated based on the total quantity of all of the products. For example, variable costs would be calculated based on the total quantity, and then the fixed costs would be added to the total variable cost to product the total estimated cost. Then, the appropriate markup would be added to generate the quotation.

The illustrated embodiment of the present invention uses any suitable commercially-available e-commerce software, such as Commerce Server provided by Microsoft Corporation of Redmond, Wash., in combination with commercially available database and/or spreadsheet software, such as Microsoft Access and Microsoft Excel, provided by Microsoft Corporation, configured to perform the various features of the present invention.

In accordance with the present invention, the illustrated embodiment includes a plurality of tables, lists, databases and/or spreadsheets configured to store information used to perform the various features of the present invention, including but not limited to, information related to: estimated costs; paper items, ribbons, suppliers, paper types, shipping and truck freight rates.

Although specific illustrated embodiments of the invention have been disclosed, it is understood by those of skill in the art that changes in form and details may be made without departing from the spirit and scope of the invention. The present invention is in no way limited to the details disclosed herein. Accordingly, the present invention is to be defined and limited solely by the scope of the claims.

We claim:

1. A method for estimating the cost of a custom-printed paper roll for use in a printer application, the method comprising the steps of:
receiving a request for a custom-printed paper roll, the request including a roll diameter and a paper type, and
estimating a cost of manufacturing the requested custom-printed paper roll based at least in part on the roll diameter and the paper type.

2. The method of claim 1, wherein the custom-printed paper roll comprises thermal, carbonless, bond, or pressure-sensitive label material.

3. The method of claim 1, wherein the custom-printed paper roll is designed to be used in a printer application.

4. A method for estimating the cost of a custom-processed paper product, the method comprising the steps of:
receiving a request for a custom-processed paper product, the request including at least one product requirement, and
determining an estimated cost of manufacturing the requested custom-processed paper product based at least in part on the at least one product requirement.

5. The method of claim 4, wherein the custom-processed paper product is selected from a group consisting of roll, fan-folded, and sheeted material utilizing thermal, bond, carbonless, or pressure-sensitive label material.

6. The method of claim 4, wherein the custom-processed paper product is designed for use in a printer application.

7. The method of claim 4, wherein the request is received over a network.

8. The method of claim 4, wherein the request is received from a first computing device and the estimated cost of manufacturing the requested custom-processed paper product is determined by a second computing device.

9. The method of claim 4, further comprising the step of applying a markup to the estimated cost.

10. The method of claim 9, further comprising the step of preparing a quotation based at least in part on the marked-up estimated cost.

11. The method of claim 10, further comprising the step of communicating the quotation to a requester.

12. The method of claim 4, wherein the requested product is selected from a plurality of products stored in a database.

13. The method of claim 12, wherein the requested product is selected from the database based on at least one product specification.

14. The method of claim 13, wherein the at least one product specification is selected from the group consisting of paper type, machine make or model, roll diameter, number of colors, quantity requested.

15. The method of claim 11, wherein the quotation is delivered to the requester electronically.

16. The method of claim 15, wherein the quotation is delivered to the requester in real time.

17. The method of claim 12, wherein the requested product is determined electronically based on a plurality of specifications.

18. The method of claim 4, wherein the estimated cost of manufacturing the custom-processed paper product is determined based on a plurality of cost factors relating to the manufacture of the custom-processed paper product.

19. The method of claim 4, wherein the step of determining an estimated cost includes the steps of:
estimating a total variable cost associated with the manufacture of the custom-processed paper product based at least in part on the at least one requirement,
estimating a total fixed cost associated with the manufacture of the custom-processed paper product based at least in part on the at least one requirement, and
generating an estimated cost of manufacturing the custom-processed paper product based at least in part on the total variable cost and the total fixed cost.

20. The method of claim 19, wherein the total variable cost is estimated based on at least one variable cost factor relating to the manufacture of the custom-processed paper product.

21. The method of claim 20, wherein the at least one variable cost factor is one of paper type, paper color, product width, product length, product diameter, product quantity, number of colors, number of parts, perforation requirements, printing requirements, and packaging requirements.

22. The method of claim 19, wherein the total fixed cost is estimated based on at least one fixed cost factor relating to the manufacture of the custom-processed paper product.

23. The method of claim 22, wherein the at least one fixed cost factor is one of paper type, paper color, number of colors to be printed, number of parts, perforation requirements, and equipment setup costs.

24. The method of claim 19, wherein the total variable cost is calculated based on at least one of a paper cost, waste cost, labor cost, and printing cost.

25. The method of claim 19, wherein the total fixed cost is calculated based on at least one of a machine setup cost and a plate printing cost.

26. A method for generating a quotation for a custom-processed paper product, the method comprising the steps of:
receiving at least one requirement for a custom-processed paper product from a requester over a network,
estimating a cost of manufacturing the custom-processed paper product based at least in part on the at least one requirement,
generating a quotation based at least in part on the estimated cost of manufacturing the custom-processed paper product, and
communicating the quotation to the requester.

27. The method of claim 26, wherein the step of generating a quotation includes the step of applying a markup to the cost of manufacturing the custom-processed paper product.

28. The method of claim 26, wherein the step of generating a quotation includes the steps of selecting a desired mark-up from a plurality of possible markups and applying the selected markup to the cost of manufacturing the custom-processed paper product.

29. The method of claim 27, wherein the markup is determined based on at least one of a plurality of mark-up factors.

30. The method of claim 29, wherein the plurality of mark-up factors includes quantity requested, product type, and product features.

31. The method of claim 26, wherein the cost of manufacturing the paper product is determined by selecting a manufacturer based on a cost quoted by the manufacturer.

32. The method of claim 26, wherein the at least one requirement includes a first requirement for a first paper product and a second requirement for a second paper product, the step of estimating a cost of manufacturing includes estimating a cost of manufacturing the first and second paper products based at least in part on the first and second requirements, and the step of generating a quotation includes generating a quotation based at least in part on the estimated cost of manufacturing the first and second paper products.

33. The method of claim 26, wherein the step of estimating a cost of manufacturing the custom-processed paper product includes the steps of:
electronically communicating the request to a plurality of potential suppliers,
receiving at least one bid from the plurality of potential suppliers, and
selecting a desired bid from the at least one bid.

34. A method for estimating the cost of a custom-processed paper product for use in a printer application, the method comprising the steps of:
receiving a request for a custom-processed paper product,
generating a plurality of estimated costs of manufacturing the requested custom-processed paper product for a plurality of alternative methods of manufacture,
determining a plurality of productivity values associated with the alternative methods of manufacture,
evaluating each of the estimated costs of manufacturing the requested custom-processed paper product in view of the plurality of productivity values, and
selecting a desired cost estimate from the plurality of estimated costs based on the results of the evaluating step.

35. The method of claim 34, wherein the custom-processed paper product is selected from a group consisting of roll, fan-folded, or sheeted product utilizing thermal, bond, carbonless, or pressure-sensitive label material.

36. The method of claim 34, wherein the plurality of alternative methods of manufacture includes a first method involving a narrow format printing press and a second method involving a wide format printing press.

37. The method of claim 34, wherein the desired cost estimate is determined to be the most cost effective of the plurality of estimated costs.
